(19) United States
(12) Patent Application Publication
(10) Pub. No.: US 2025/0153189 A1
(43) Pub. Date: May 15, 2025

(54) ELECTRIC DUST COLLECTING APPARATUS AND AIR CONDITIONER INCLUDING SAME

(71) Applicant: Samsung Electronics Co., Ltd., Suwon-si (KR)

(72) Inventors: Myungsoo KANG, Suwon-si (KR); Hyongsoo NOH, Suwon-si (KR); Hyeongjoon SEO, Suwon-si (KR); Myungseob SONG, Suwon-si (KR); Kyuho SHIN, Suwon-si (KR); Joonoh SHIN, Suwon-si (KR); Kisup LEE, Suwon-si (KR)

(21) Appl. No.: 19/024,754

(22) Filed: Jan. 16, 2025

Related U.S. Application Data
(63) Continuation of application No. PCT/KR2023/012094, filed on Aug. 16, 2023.

(30) Foreign Application Priority Data
Sep. 19, 2022 (KR) 10-2022-0118221

(51) Int. Cl. B03C 3/38; B03C 3/41

(52) U.S. Cl. CPC B03C 3/38; B03C 3/41; B03C 2201/04

(57) ABSTRACT

A high-efficiency electric dust collecting apparatus comprises: an electrifying unit; and a dust collecting assembly configured to collecting foreign substances electrified in the electrifying unit, wherein the electrifying unit comprises: a plurality of corresponding electrodes; at least one discharging electrode arranged between the plurality of corresponding electrodes; a first power source configured to apply a first voltage across both ends of the discharging electrode; and a second power source configured to apply a second voltage to each of the plurality of corresponding electrodes, wherein the first power source and the discharging electrode form a closed circuit, and the second power source and the plurality of corresponding electrodes form an open circuit.

### CROSS-REFERENCE TO RELATED APPLICATIONS

This application is a continuation of International Application No. PCT/KR2023/012094 designating the United States, filed on Aug. 16, 2023, in the Korean Intellectual Property Receiving Office and claiming priority to Korean Patent Application No. 10-2022-0118221, filed on Sep. 19, 2022, in the Korean Intellectual Property Office, the disclosures of each of which are incorporated by reference herein in their entireties.

### BACKGROUND

### Field

The disclosure relates to an electrostatic precipitator configured to heat a discharging electrode and an air conditioner including the same.

### Description of Related Art

High-concentration of aerosols in indoor spaces such as homes, rooms, shopping malls, factories, and offices may cause problems to people's health. These aerosols may be generated by smoking, cooking, cleaning, welding, grinding, etc. in indoor spaces.

An electrostatic precipitator is a device for removing such aerosols and may be used in an air purifier and an air conditioner having an air cleaning function.

The electrostatic precipitator may include a charging assembly configured to charge foreign substances in the air, and a dust collecting assembly configured to collect the foreign substances charged by the charging assembly.

The charging assembly uses a high voltage to generate a corona discharge, but when a high voltage is applied, ozone corresponding to a hazardous substance may be generated.

### SUMMARY

Embodiments of the disclosure provide an electrostatic precipitator having high efficiency and an air conditioner including the same.

An example embodiment of the present disclosure provides an electrostatic precipitator including: a charging assembly; and a dust collecting assembly comprising a sheet configured to collect foreign substances charged in the charging assembly. The charging assembly includes a plurality of counter electrodes; at least one discharging electrode arranged between the plurality of counter electrodes; a first power source comprising power supply circuitry configured to apply a first voltage to both ends of the discharging electrode; and a second power source configured to apply a second voltage to each of the plurality of counter electrodes. The first power source and the discharging electrode form a closed circuit, and the second power source and the plurality of counter electrodes form an open circuit.

A magnitude of the second voltage may be greater than a magnitude of the first voltage.

The magnitude of the second voltage may be 1000 V or greater and the magnitude of the first voltage may be 20 V or less.

The first power source may include an alternating current (AC) power source or a direct current (DC) power source, and the second power source may be a DC power source.

The discharging electrode may be configured to generate heat by the first voltage, and a corona discharge may occur at the discharging electrode by the second voltage.

The discharging electrode may have a specified resistance value, and the magnitude of the first voltage may be specified based on the specified resistance value.

The at least one discharging electrode may include a plurality of discharging electrodes spaced apart from each other in a downstream direction from the charging assembly to the dust collecting assembly.

The plurality of discharging electrodes may be connected in parallel to the first power source.

The first power source may be configured to apply the first voltage to both ends of the discharging electrode based on a start of operation of the electrostatic precipitator.

The second power source may apply the second voltage to each of the plurality of counter electrodes based on a lapse of a specified time after the operation of the electrostatic precipitator starts.

The electrostatic precipitator may further include a current sensor configured to detect a current flowing in a closed circuit formed by the first power source and the discharging electrode.

The first power source may be configured to adjust the first voltage to allow the current value detected by the current sensor to be maintained at a predetermined value.

One end of the first power source may be connected to the discharging electrode, and an other end of the first power source may be connected to ground and the discharging electrode.

The first power source and the discharging electrode may have a grounded common node.

One end of the second power source may be connected to each of the plurality of counter electrodes, and an other end of the second power source may be connected to ground.

The plurality of counter electrodes may be ungrounded.

The discharging electrode may comprise a wire electrode.

The counter electrode may comprise a plate electrode.

The discharging electrode may extend in a direction perpendicular to the downstream direction from the charging assembly to the dust collecting assembly and in a direction in parallel to the counter electrode.

The number of the plurality of counter electrodes may be greater than the number of the at least one discharging electrode.

The number of the plurality of counter electrodes may be less than the number of the at least one discharging electrode.

Embodiments of the disclosure may also provide an air conditioner including an electrostatic precipitator.

The air conditioner may further include a user interface device configured to receive an input (e.g., a user input) for executing a cleaning mode.

The electrostatic precipitator may operate based on receiving the input.

A high-efficiency electrostatic precipitator is provided.

An electrostatic precipitator with improved ion generation efficiency is provided.

An electrostatic precipitator having a low discharge inception voltage is provided.

An electrostatic precipitator configured to prevent and/or reduce foreign substances from adhering to a discharging electrode is provided.

An electrostatic precipitator with reduced ozone generation is provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example electrostatic precipitator according to various embodiments;

FIG. 2 is a diagram illustrating an electrostatic precipitator according to various embodiments;

FIG. 3 is a perspective view illustrating an electrostatic precipitator according to various embodiments;

FIG. 4 is an exploded perspective view of the electrostatic precipitator shown in FIG. 3 according to various embodiments;

FIGS. 5 and 6 diagrams illustrating an example of a circuit forming a charging assembly according to various embodiments;

FIG. 7 is a diagram illustrating an example of a closed circuit including a discharging electrode and an open circuit including a counter electrode according to various embodiments;

FIG. 8 is a block diagram illustrating an example configuration of an electrostatic precipitator according to various embodiments;

FIG. 9 is a diagram illustrating principles of corona discharge and particle charging according to various embodiments;

FIG. 10 is a diagram illustrating principles of preventing/reducing discharging electrode contamination by thermophoresis according to various embodiments;

FIG. 11 is a flowchart illustrating an example method of controlling the electrostatic precipitator according to various embodiments;

FIG. 12 is a perspective view illustrating an exterior of an air conditioner according to various embodiments;

FIG. 13 is a block diagram illustrating an example configuration of the air conditioner according to various embodiments; and

FIG. 14 is a flowchart illustrating an example method of controlling the air conditioner according to various embodiments.

### DETAILED DESCRIPTION

Embodiments described in the disclosure and configurations shown in the drawings are merely examples of the disclosure, and may be modified in various different ways at the time of filing of the present application.

The terms used herein are used to describe the various example embodiments and are not intended to limit and/or restrict the disclosure.

The singular forms “a,” “an” and “the” are intended to include the plural forms as well, unless the context clearly indicates otherwise.

In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

It will be understood that, although the terms first, second, third, etc., may be used herein to describe various elements, but elements are not limited by these terms.

In the following description, terms such as “unit”, “part”, “block”, “member”, and “module” indicate a unit for processing at least one function or operation. For example, those terms may refer to at least one process processed by at least one hardware such as Field Programmable Gate Array (FPGA), Application Specific Integrated Circuit (ASIC), at least one software stored in a memory or a processor.

The disclosure will be described more fully hereinafter with reference to the accompanying drawings. The same reference numerals or signs shown in the drawings of the disclosure indicate elements or components performing substantially the same function.

Reference will now be made in detail to various embodiments of the disclosure, examples of which are illustrated in the accompanying drawings.

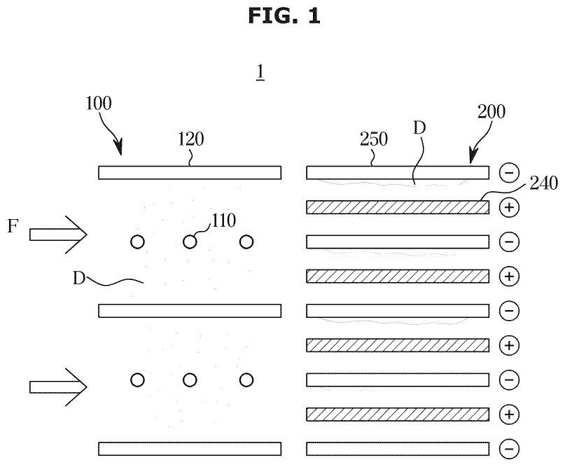

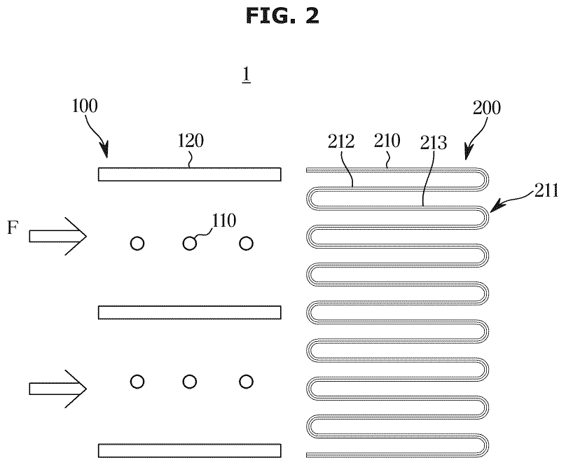

FIG. 1 is a diagram illustrating an example electrostatic precipitator according to various embodiments, and FIG. 2 is a diagram illustrating the electrostatic precipitator according to various embodiments.

Referring to FIGS. 1 and 2, an electrostatic precipitator 1 according to an embodiment of the present disclosure may include a charging assembly 100 and a dust collecting assembly 200.

The electrostatic precipitator 1 may be disposed in a housing (not shown), and outside air that is drawn into the charging assembly 100 through a blower fan (not shown) provided upstream or downstream of the electrostatic precipitator 1 may pass through the dust collecting assembly 200 and be discharged back to the outside. The electrostatic precipitator 1 according to an embodiment of the present disclosure may be disposed inside an air conditioner.

The discharge unit 100 is a configuration for charging pollutants D, such as dust, in the air and may include a plurality of discharging electrodes 110 and a plurality of counter electrodes 120. At least one discharging electrode 110 may be disposed between a pair of counter electrodes 120.

In an embodiment, one discharging electrode 110 may be disposed between the pair of counter electrodes 120.

According to various embodiments, the plurality of discharging electrodes 110 may be disposed between the pair of counter electrodes 120.

The plurality of discharging electrodes 110 may be spaced apart in a downstream direction from the charging assembly 100 to the dust collecting assembly 200.

A distance between each of the pair of counter electrodes 120 and each of the plurality of discharging electrodes 110 arranged therebetween may be the same.

When a predetermined (e.g., specified) voltage is applied to the discharging electrode 110 and/or the counter electrode 120, a corona discharge may occur between the at least one discharging electrode 110 and the pair of counter electrodes 120, thereby charging pollutants passing through the charging assembly 100.

The discharging electrode 110 may be formed as a wire electrode, and the discharging electrode 110 may be a tungsten wire. However, examples of the discharging electrode 110 are not limited thereto, and any metal in the form of a wire that generates heat according to the flow of current may be employed as the discharging electrode 110.

The discharging electrode 110 may extend in a direction perpendicular to a downstream direction F, which is from the discharge unit 100 to the dust collecting assembly 200, and may extend in a direction parallel to the counter electrode 120.

The counter electrode 120 may be formed as a plate electrode, and may be formed as a conductive metal plate. For example, the counter electrode 120 may be formed as an aluminum plate. However, examples of the counter electrode 120 are not limited thereto.

According to various embodiments, when one discharging electrode 110 is disposed between a pair of counter electrodes 120, the number of the plurality of counter electrodes 120 may be greater than the number of the plurality of discharging electrodes 110.

According to an embodiment, when a plurality of discharging electrodes is arranged between a pair of counter electrodes 120, the number of the plurality of discharging electrodes 110 may be greater than the number of the plurality of counter electrodes 120.

The above-mentioned charging assembly 100 may be a wire-plate structure that uses a high-voltage discharge, but may include various means for charging pollutants with a specific polarity, in addition to a discharge using a carbon brush electrode or a needle-shaped electrode.

In an embodiment, a corona discharge may be generated at the discharging electrode 110 by applying a high voltage to the counter electrode 120. Accordingly, foreign substances D in the air surrounding the discharging electrode 110 may be charged to a positive pole.

An example of applying power to the discharging electrode 110 and the counter electrode 120 forming the discharge unit 100, and the principle of corona discharge will be described in detail later.

The dust collecting assembly 200 is configured to collect foreign substances D charged in the charging assembly 100, and may include a dust collecting sheet 210 in the form of a continuously bending sheet.

The dust collecting sheet 210 may include a plurality of bending portions 211 formed by continuously bending a single dust collecting sheet 210 in a zigzag pattern. For example, as illustrated in FIG. 2, the dust collecting sheet 210 may have a rectangular shape in which a vertical length is longer than a horizontal width when unfolded based on FIG. 2, and may form the plurality of bending portions 211 by being continuously bent in a zigzag pattern along a longitudinal direction. However, the dust collecting sheet is not limited thereto and may be provided in such a way that the horizontal length is longer than the vertical length. Further, the dust collecting sheet may include a plurality of bending portions 211 formed by being continuously bent in a zigzag pattern along the horizontal direction according to the shape of the electrostatic precipitator 1 including the dust collecting assembly 200.

The dust collecting assembly 200 may be configured to allow the plurality of bending portions 211 to be disposed between the pair of counter electrodes 120 of the charging assembly 100. For example, the dust collecting assembly 200 may be configured to allow ten bending portions 211 to be disposed between the pair of counter electrodes 120. Accordingly, the charged pollutants introduced into the dust collecting assembly 200 may be effectively adsorbed onto the dust collecting assembly 200.

As mentioned above, the dust collecting sheet 210 may be configured to allow a plurality of first planes 212 and a plurality of second planes 213 to be alternately and continuously arranged in parallel, and the bending portion 211 connecting the first plane 212 and the second plane 213 may be formed in a zigzag shape in opposite directions as the dust collecting sheet 210 is bent in a zigzag shape.

In addition, as a first electrode 240 is arranged on the first plane 212 and a second electrode 250 is arranged on the second plane 213, a plurality of first electrodes 240 and a plurality of second electrodes 250 alternately arranged inside the dust collecting sheet 210 may be arranged to face each other by the plurality of bending portions 211.

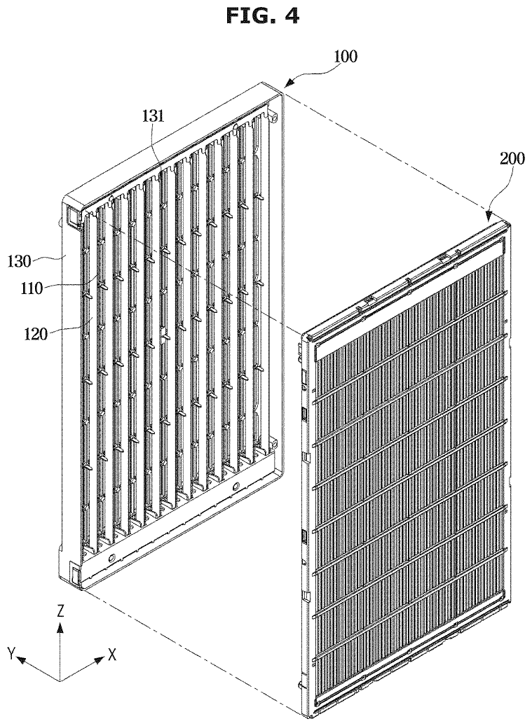

The plurality of first electrodes 240 and the plurality of second electrodes 250 alternately arranged inside the dust collecting sheet 210 may have a substantially rectangular shape formed to elongate along a width direction of the dust collecting sheet 210 (e.g., Z direction in FIG. 4).

The bending portion 211 may be a bent shape to allow a section between the first plane 212 and the second plane 213 of the dust collecting sheet 210 to form a curved surface. In addition, the bending portion 211 may be a shape of a plane that is bent in a vertical direction from the first plane 212 and the second plane 213, and may also be formed as a shape of an edge formed by folding a section between the first plane 212 and the second plane 213 of the dust collecting sheet 210 in a straight line.

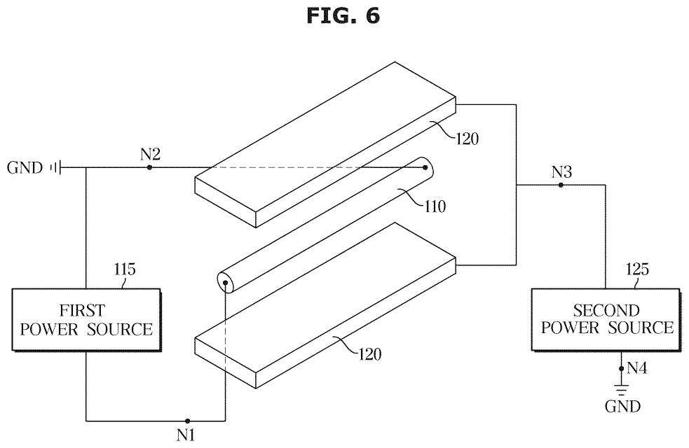

The plurality of bending portions 211 of the dust collecting sheet 210 may be formed between the plurality of first electrodes 240 and the plurality of second electrodes 250, respectively. Accordingly, the plurality of bending portions 211 is formed in a zigzag pattern along the longitudinal direction (X direction of FIG. 6) of the dust collecting sheet 210 between the plurality of first electrodes 240 and the plurality of second electrodes 250.

On one side of the bending portion 211, the first plane 212 including the first electrode 240 therein may be disposed, and on the other side of the bending portion 211, the second plane 213 including the second electrode 250 therein may be disposed to face the first plane 212. Accordingly, the plurality of first electrodes 240 and the plurality of second electrodes 250 may be arranged to be alternately stacked along the longitudinal direction of the dust collecting sheet 210.

In addition, the first plane 212 including the first electrode 240 therein, the bending portion 211, and the second plane 213 including the second electrode 250 therein may be arranged continuously, and thus pollutants in the air passing between the plurality of first planes 212 and the plurality of second planes 213 may be easily collected.

By applying power having different polarities to the plurality of first electrodes 240 and the plurality of second electrodes 250 respectively disposed inside the plurality of first planes 212 and the plurality of second planes 213 facing each other, an electric field may be formed between the first electrode 240 and the second electrode 250.

For example, the plurality of first electrodes 240 may be configured as high-voltage electrodes, and the plurality of second electrode 250 may be configured as low-voltage electrodes having a lower voltage than the first electrode 240. For example, a high-voltage power source may be applied to the plurality of first electrodes 240, and the plurality of second electrodes 250 may be grounded, thereby forming a voltage difference between the first electrode 240 and the second electrode 250.

In addition, an electric field may be formed between the first electrode 240 and the second electrode 250 by applying power of the positive pole to the plurality of first electrodes 240 and applying power of the negative pole to the plurality of second electrodes 250.

Accordingly, pollutants that are positively charged by passing through the charging assembly 100 may be adsorbed on the second electrode 250, which is a negative electrode, e.g., on the second plane 213 including the second electrode 250 therein, while passing through a gap between the first plane 212 and the second plane 213.

According to various embodiments, an electric field may be formed between the first electrode 240 and the second electrode 250 by applying power of the negative pole to the plurality of first electrodes 240 and applying power of the positive pole to the plurality of second electrodes 250.

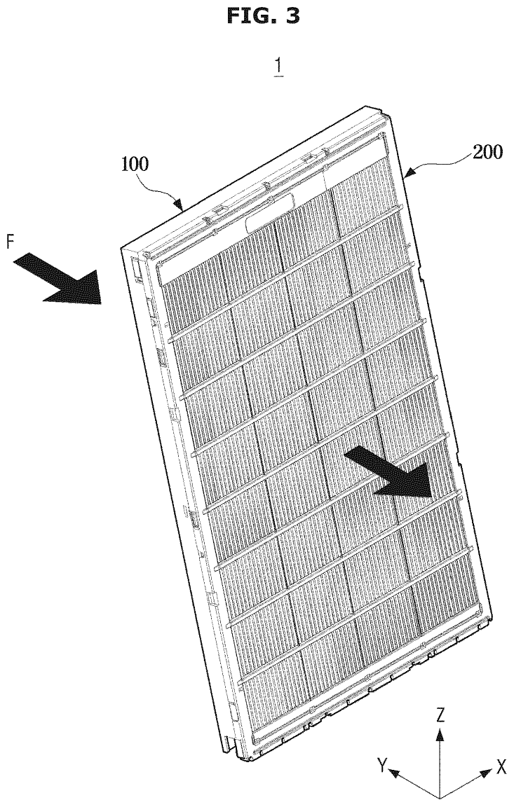

FIG. 3 is a perspective view illustrating the electrostatic precipitator according to various embodiments, and FIG. 4 is an exploded perspective view of the electrostatic precipitator shown in FIG. 3 according to various embodiments.

As illustrated in FIGS. 3 and 4, the electrostatic precipitator 1 includes the charging assembly 100 and the dust collecting assembly 200 coupled to face the charging assembly 100. Accordingly, outside air may sequentially pass from the charging assembly 100 to the dust collecting assembly 200 in the direction F shown in FIG. 3, and thus pollutants contained in the outside air may be removed.

As described above, the charging assembly 100 may include the plurality of counter electrodes 120 and the at least one discharging electrode 110 respectively disposed between the plurality of counter electrodes 120. In addition, the charging assembly 100 may include a charging cover 130 provided to support the plurality of discharging electrodes 110 and the plurality of counter electrodes 120.

As illustrated in FIG. 4, the plurality of discharging electrodes 110 and the plurality of counter electrodes 120 may be formed to extend along the longitudinal direction (e.g., Z direction of FIG. 4) of the charging cover 130 on the inside of the charging cover 130, and may be arranged alternately and in parallel along the width direction (e.g., X direction of FIG. 4) of the charging cover 130.

The plurality of discharging electrodes 110 may be formed of metal wires, such as, tungsten wires, and the plurality of counter electrodes 120 may be formed of metal plates, such as aluminum, which are formed to extend along the longitudinal direction of the plurality of discharging electrodes 110.

According to the conventional manner, by applying a high voltage to a discharging electrode, pollutants contained in the air are charged to a positive (+) pole through the corona discharge of the discharging electrode.

However, as described in greater detail below, the electrostatic precipitator 1 according to an embodiment may charge pollutants contained in the air through the corona discharge of the discharging electrode 110 by applying a high voltage to the counter electrode 120 instead of the discharging electrode 110.

The charging cover 130 may be in the shape of a frame that fixes both ends of the plurality of discharging electrodes 110 and the plurality of counter electrodes 120, and may include a plurality of inlets 131 formed in a grid on an inside of the charging cover. Outside air may be introduced through the plurality of inlets 131 of the charging cover 130, and pollutants included in the introduced air may be charged through the corona discharge between the plurality of discharging electrodes 110 and the plurality of counter electrodes 120, and may move to the dust collecting assembly 200 arranged downstream of the charging assembly 100.

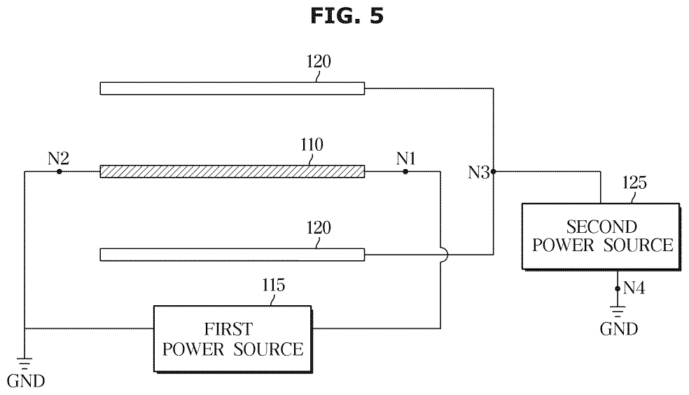

FIGS. 5 and 6 are diagrams illustrating examples of a circuit forming a charging assembly according to various embodiments.

Referring to FIGS. 5 and 6, the charging assembly 100 may include a first power source 115 configured to apply a first voltage to the discharging electrode 110 and a second power source 125 configured to apply a second voltage to the counter electrode 120.

The first power source 115 may apply the first voltage to both ends of the discharging electrode 110.

The first power source 115 and the discharging electrode 110 may form a closed circuit. Accordingly, a current may flow through the discharging electrode 110.

One end N1 of the first power source 115 may be connected to one end of the discharging electrode 110, and the other end N2 of the first power source 115 may be connected to a ground (GND).

One end N1 of the discharging electrode 110 may be connected to the first power source 115, and the other end N2 of the discharging electrode 110 may be connected to the ground (GND).

For example, the discharging electrode 110 and the first power source 115 may have a grounded common node N2 and may have a common node N1 to which the first voltage is applied.

The first power source 115 may be a direct current (DC) power source or an alternating current (AC) power source.

When the first power source 115 is configured as a DC power source, a first voltage in the form of a DC voltage may be applied to the one end N1 of the discharging electrode 110. At this time, the first voltage may be a voltage of a positive or negative pole, and a magnitude of the first voltage may be 20 V or less (e.g., about 5 V to 10 V). Hereinafter for the convenience of description, it is assumed that the first voltage is a voltage of a positive pole, but the first voltage may also correspond to a voltage of a negative pole, and the same description may be applied thereon.

When the second power source 125 is configured as an AC power source, a first voltage in the form of an AC voltage may be applied to the one end N1 of the discharging electrode 110. At this time, an average magnitude of the first voltage may be 20 V or less.

Due to potential difference between the two ends N1 and N2, a current may flow through the discharging electrode 110.

As mentioned above, the discharging electrode 110 may be implemented as a metal wire. According to an inherent resistance value of the metal wire and a diameter and length of the discharging electrode, the discharging electrode 110 may have a predetermined (e.g., specified) resistance value.

A magnitude of the first voltage may be predetermined based on the predetermined resistance value of the discharging electrode 110.

For example, the first voltage may have a voltage value that allows a current of a predetermined (e.g., specified) magnitude to flow through the discharging electrode 110.

The predetermined magnitude may be set to a magnitude of a current that heats the discharging electrode 110 to a predetermined temperature.

The discharging electrode 110 may generate heat based on the current flowing through the discharging electrode 110 by the first voltage.

Accordingly, in an embodiment, the discharging electrode 110 may be used as a heating element.

Similarly, when the plurality of discharging electrodes 110 is arranged between the pair of counter electrodes 120, the first voltage may be applied to both ends of the plurality of discharging electrodes 110 from the first power source 115, and accordingly, a current of a predetermined magnitude may flow through each of the plurality of discharging electrodes 110.

The second power source 125 may apply a second voltage to one end N3 of each of the plurality of counter electrodes 120.

The second power source 125 and each of the plurality of counter electrodes 120 may form an open circuit. Accordingly, no current flows through the counter electrode 120.

The one end N3 of the second power source 125 may be connected to the counter electrode 120, and the other end N4 of the second power source 125 may be connected to the ground (GND).

The one end N3 of the counter electrode 120 may be connected to the second power source 125, and the other end of the counter electrode 120 may be open.

For example, the counter electrode 120 and the second power source 125 may not have a grounded common node, but may only have a common node N3 to which the second voltage is applied.

The second power source 125 may be implemented as a DC power source for applying a second voltage.

The second power source 125 is configured to apply a voltage to allow a corona discharge phenomenon to occur, and the second voltage may correspond to a high voltage.

For example, a magnitude of the second voltage in the form of DC power applied by the second power source 125 may be 1000 V or more (e.g., about 1000 V to 10000 V).

In order to allow a corona discharge phenomenon to occur, the second voltage may be a voltage of the negative pole. For example, the second voltage may be −1000 V to −10000 V.

Accordingly, a corona discharge may occur between the counter electrode 120 and the discharging electrode 110.

As described in greater detail below, when the second voltage is applied to the counter electrode 120, a corona discharge may occur near the discharging electrode 110 having a small radius of curvature.

According to the present disclosure, the discharging electrode 110 may be heated by forming a closed circuit with the first power source 115, and thus effects resulting from the heating of a discharge space may be obtained.

In addition, according to the present disclosure, damage to the low-voltage power supply device caused by a high voltage may be prevented and/or reduced because the circuit formed by the first power source 115 and the circuit formed by the second power source 125 do not contact each other.

In addition, according to the present disclosure, in an embodiment, the plurality of discharging electrodes 110 is arranged between the pair of counter electrodes 120, thereby maximizing/increasing the effect of heat generation in the discharge space.

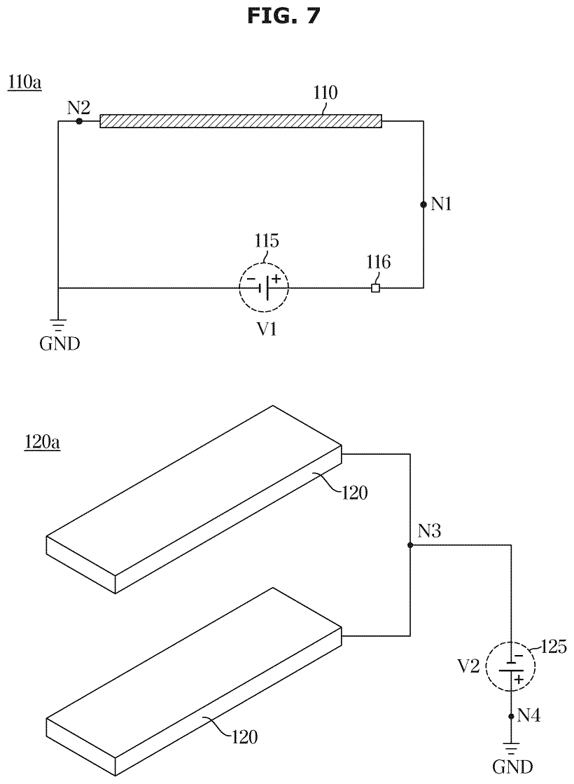

FIG. 7 is a diagram illustrating an example of a closed circuit including a discharging electrode and an open circuit including a counter electrode according to various embodiments.

Referring to FIG. 7, a closed circuit 110a including the discharging electrode 110 may be implemented in a form in which both ends of the discharging electrode 110 are connected to both ends of the first power source 115.

The discharging electrode 110 and the first power source 115 may have the grounded common node N2 and may have the common node N1 to which a first voltage V1 of the positive pole is supplied.

According to various embodiments, when the plurality of discharging electrodes 110 is provided, the plurality of discharging electrodes may be connected in parallel to the first power source 115. In this case, the closed circuit 110a may include the plurality of discharging electrodes 110 connected in parallel.

According to various embodiments, the closed circuit 110a may include a first discharging electrode 110 disposed between a pair of counter electrodes 120 and a second discharging electrode 110 disposed between another pair of counter electrodes 120.

As illustrated in FIGS. 1 and 2, the counter electrode 120 and the discharging electrode 110 are arranged alternately, and at least one discharging electrode 110 is arranged between the pair of counter electrodes 120.

Accordingly, the plurality of discharging electrodes 110 included in the electrostatic precipitator 1 may be connected in parallel to the first power source 115 to form the closed circuit 110a.

According to various embodiments, the closed circuit 110a may include a current sensor 116 for detecting a current flowing in the discharging electrode 110.

In an embodiment, the current sensor 116 may detect a magnitude of a current flowing to the discharging electrode 110.

One end of each of the plurality of counter electrodes 120 may be connected to the second power source 125, and each of the plurality of counter electrodes 120 may form an open circuit 120a.

The open circuit 120a including the counter electrode 120 may be implemented in a form in which one end of the counter electrode 120 is connected to one end of the second power source 125.

The counter electrode 120 and the second power source 125 may not have a grounded common node, but may have a common node N3 to which a second voltage V2 of the negative pole is supplied.

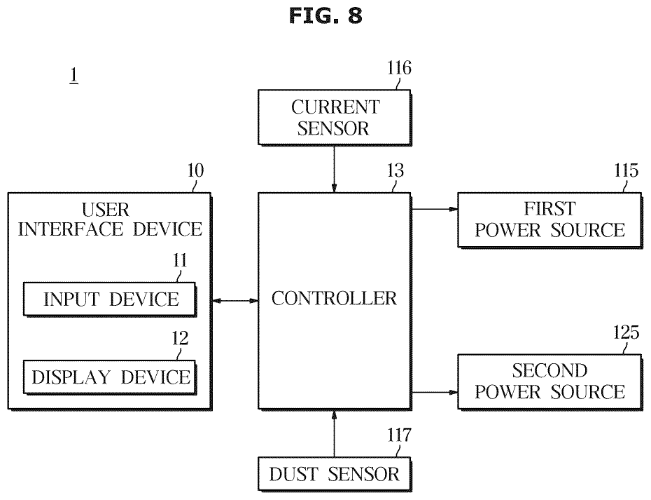

FIG. 8 is a block diagram illustrating an example configuration of the electrostatic precipitator according to various embodiments.

Referring to FIG. 8, the electrostatic precipitator 1 may include a user interface device (e.g., including interface circuitry) 10, the current sensor 116, a dust sensor 117, the first power source 115, the second power source 125, and a controller (e.g., including circuitry) 13.

The user interface device 10 may include various circuitry including, for example, an input device 11 provided to receive a user input for controlling the operation of the electrostatic precipitator 1, and a display device 12 provided to display setting and/or operation information in response to the user input.

The user interface device 10 may provide a user interface for interaction between a user and the electrostatic precipitator 1.

The input device 11 may include a power button, an operation button, a course selection dial, and a detailed setting button. In addition, the input device 11 may be provided with a tact switch, a push switch, a slide switch, a toggle switch, a micro switch, or a touch switch. In addition, the input device 11 may include a communication module for receiving a user input from a remote-control device.

The display device 12 may include a screen provided to display various types of information and an indicator provided to display detailed settings selected by a setting button. The display device 12 may include a liquid crystal display (LCD) panel and/or a light emitting diode (LED), but is not so limited.

The user interface device 10 may receive a start command to initiate an operation of the electrostatic precipitator 1 and a setting command to set operation specifications of the electrostatic precipitator 1.

The operation specifications of the electrostatic precipitator 1 may include a speed of a blower fan, an intensity of dust collection, etc.

The controller 13 may include at least one processor, comprising processing circuitry, configured to generate a control signal regarding the operation of the electrostatic precipitator 1, and a memory provided to store a program, an application, an instruction, and/or data for the operation of the electrostatic precipitator 1. The processor and the memory may be implemented as separate semiconductor devices, or may be implemented as a single semiconductor device. In addition, the controller 13 may include a plurality of processors or a plurality of memories. The controller 13 may be provided at various locations inside the electrostatic precipitator 1.

The processor may include arithmetic circuits, memory circuits, and control circuits. The processor may include one chip or may include a plurality of chips. Additionally, the processor may include one core or may include a plurality of cores. The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory may store a program for performing a washing cycle according to a washing course and data including washing settings according to the washing course. In addition, the memory may store the currently selected dust collection settings based on a user input.

According to an embodiment, the memory may store an algorithm for performing a dust collection operation according to a dust collection setting, and data for controlling the charging assembly 100 and the dust collecting assembly 200 when performing the dust collection operation.

The memory may include volatile memory such as Static Random Access Memory (S-RAM) and Dynamic Random Access Memory (D-RAM), and nonvolatile memory such as Read Only Memory (ROM) and Erasable Programmable Read Only Memory (EPROM).

The processor may process data and/or signals using a program provided from the memory, and transmit a control signal to each component of the electrostatic precipitator 1 based on the processing result. For example, the processor may process a user input received through the user interface device 10. In response to the user input, the processor may output a control signal for controlling the first voltage applied to both ends of the discharging electrode 110 and/or a control signal for controlling the second voltage applied to one end of the counter electrode 120.

According to various embodiments, the controller 13 may control the first power source 115 to control a timing and/or period of time that the first voltage is applied to both ends of the discharging electrode 110, and may control the second power source 125 to control a timing and/or period of time that the second voltage is applied to one end of the counter electrode 120.

According to various embodiments, the controller 13 may receive data on the magnitude of the current flowing to the discharging electrode 110 from the current sensor 116.

Accordingly, the controller 13 may control the first power source 115 based on a current value received from the current sensor 116.

The dust sensor 117 may measure a dust concentration of the air surrounding the electrostatic precipitator 1. For example, the dust sensor may include an infrared sensor.

The controller 13 may perform the dust collection operation based on dust information received from the dust sensor 117. For example, the controller 13 may increase a rotation speed of the blower fan and increase a magnitude of the second voltage as the dust concentration increases.

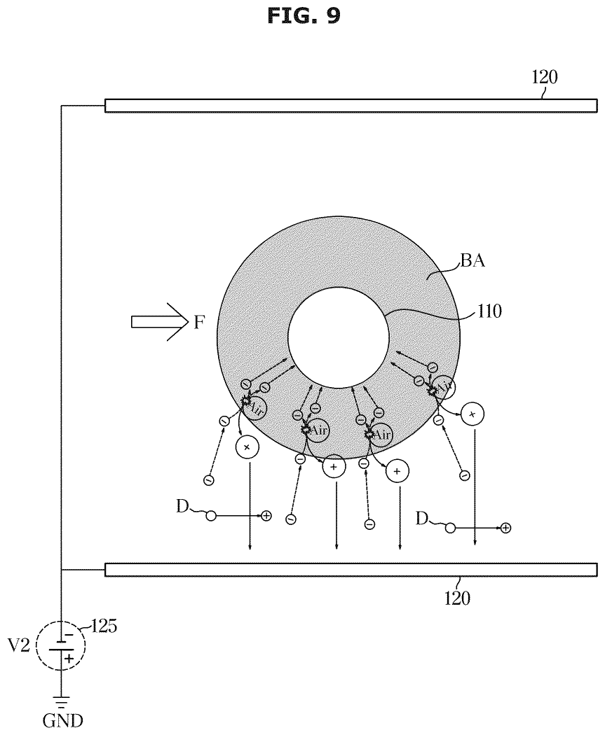

FIG. 9 is a diagram illustrating principles of corona discharge and particle charging according to various embodiments.

Referring to FIG. 9, the discharging electrode 110 has a radius of curvature less than that of the counter electrode 120. When the first voltage is applied to both ends of the discharging electrode 110 and the second voltage is applied to the counter electrode 120, a strong electric field is formed around the discharging electrode 110 having a relatively small radius of curvature.

As mentioned above, the first voltage corresponds to a low voltage of the positive pole (e.g., 5 V to 10 V) and the second voltage corresponds to a high voltage of the negative pole (e.g., −1 kV to −10 kV).

Free electrons have a property of accelerating from low potential to high potential.

Free electrons present in the air are accelerated toward the discharging electrode 110, which has a relatively higher potential than the counter electrode 120, due to a strong electric field formed around the discharging electrode 110, and the accelerated free electrons collide with neutral gas molecules in the air to generate a large number of positive ions and free electrons, causing a corona discharge to occur around the discharging electrode 110.

Free electrons generated around the discharging electrode 110 move to the grounded node N2 (FIGS. 4 and 5) and are absorbed, and positive ions move toward the counter electrode 120, to which the second voltage of the negative pole is applied.

A corona discharge may occur around the discharging electrode 110, which releases positive ions out of a discharge area, and this may be referred to as a positive corona discharge.

Due to the corona discharge, some of the positive ions passing between the discharging electrode 110 and the counter electrode 120 are attached to a foreign substance D flowing downstream (in the F direction), thereby charging the foreign substance D with positive (+) polarity.

As mentioned above, by applying the second voltage to the counter electrode 120, a corona discharge occurs at the discharging electrode 110, and the foreign substance D passing through the charging assembly 100 is charged by the positive ions released by the corona discharge.

A breakdown electric field E0 for a corona discharge to occur in air at atmospheric pressure may be calculated by the following [Equation 1].

$${E}_{0} = 3 \times {10}^{6} δ ( 1 + 0.03 / \sqrt{δ {r}_{i}} ) \qquad [ Equation 1 ]$$

(ri: radius of corona discharge wire, δ: density of air)

According to various embodiments, when it is assumed that a thickness of the discharging electrode 110, which is a wire electrode, is 90 μm, the breakdown electric field E0 to generate the corona discharge is approximately 1.25×10\hat{ }7 (V/m).

When it is assumed that a distance between the discharging electrode 110 and the counter electrode 120 is 10 μmm, the first voltage is 10 V, and the second voltage is −10 kV, a boundary area BA of the discharging electrode 110 having an electric field of 1.25×10\hat{ }7 (V/m) or more is calculated to be approximately 0.01 μmm from the surface of the discharging electrode 110.

For example, the corona discharge occurs intensively in a narrow area (BA) less than 0.01 μmm from the surface of the discharging electrode 110, and when a temperature of air within the narrow area BA is heated to approximately 50° C., various effects due to heat generation in the discharge space may be obtained.

The boundary area BA of the discharging electrode 110 may be defined as a corona discharge area BA.

As mentioned above, the first voltage may have a voltage value that causes a current of a predetermined magnitude to flow through the discharging electrode 110, and the predetermined magnitude may be set to a magnitude of current that heats the discharging electrode 110 to a predetermined temperature.

Accordingly, the predetermined magnitude may be set as a current value for heating the discharging electrode 110 to the predetermined temperature (e.g., about 60° C.).

In order to describe various effects obtained by the heating of the corona discharge area (BA), various difficulties of the electrostatic precipitator 1 according to the conventional manner will be described in greater detail below.

According to the conventional manner, when a high-power operation is performed to obtain high charging efficiency, oxygen in the air is decomposed by accelerated electrons, ions, and radicals generated within the corona discharge area, thereby generating ozone which is a harmful substance.

In addition, when using an electrostatic precipitator according to the conventional manner for a long time, dust is attached to the discharging electrode, and thus noise is generated. Further, a discharge inception voltage for generating a corona discharge gradually increases.

As a temperature of air in the corona discharge area increases, an amount of ozone generated is reduced due to thermal decomposition of ozone even when the magnitude of the second voltage is large. In other words, as the temperature of air in the corona discharge area increases, the amount of ozone generated by the corona discharge decreases, and thus the high-power operation may be performed.

According to the present disclosure, the discharging electrode 110 may increase the temperature of the air in the corona discharge area by generating heat, and thus the effect of reducing the amount of ozone generated by the corona discharge may be obtained.

As the temperature of the air in the corona discharge area increases, the discharge inception voltage for the corona discharge decreases.

For example, as a size of the breakdown electric field E0 for generating the corona discharge in air at atmospheric pressure is reduced, the corona discharge may be generated at the discharging electrode 110 even when the magnitude of the second voltage applied to the counter electrode 120 is small.

According to the present disclosure, the discharging electrode 110 may increase the temperature of the air in the corona discharge area by generating heat, and accordingly, the discharge inception voltage for the corona discharge may be lowered, thereby promoting power efficiency.

As a temperature of the surface of the discharging electrode 110 increases, the number of ions generated by the corona discharge increases.

As the temperature of the surface of the discharging electrode 110 increases, the temperature of the air in the corona discharge area increases and thus the air pressure in the corona discharge area decreases. When air density is low, a mean free path, which is a distance between air molecules, is increased and thus the number of collisions between free electrons and air molecules decreases. Accordingly, the acceleration of electrons by the electric field becomes easier.

Because the acceleration of electrons by the electric field is easy, a discharge inception voltage, at which insulation breakdown occurs and a corona discharge begins, is lowered. When the temperature of the discharge area is high in a state in which the same voltage is applied, the ionization of the air occurs more actively, which has the effect of increasing the number of ions generated.

According to the present disclosure, the discharging electrode 110 may increase the temperature of the air in the corona discharge area by generating heat, and accordingly, the number of ions released in the discharge area may be increased, thereby increasing the charging efficiency.

In addition, according to the present disclosure, the inactivation efficiency of bioaerosols (e.g., bacteria, viruses, allergens) may be significantly increased by high concentration of ions.

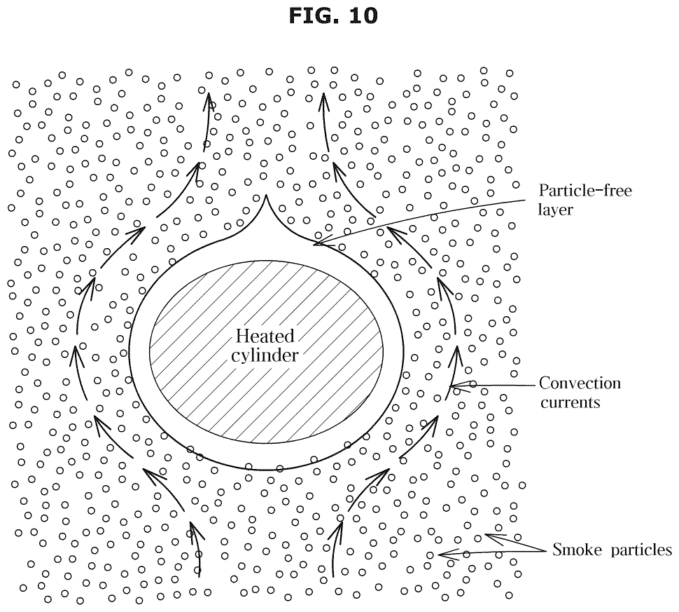

FIG. 10 is a diagram illustrating principles of preventing/reducing discharging electrode contamination by thermophoresis according to various embodiments.

Referring to FIG. 10, particles in the air tend to move from a place with high temperature to a place with low temperature due to thermophoresis. Accordingly, when the temperature of the discharging electrode 110 increases, particles passing around the discharging electrode 110 move away from the discharging electrode 110, and thus the particles attached to the discharging electrode 110 decrease. Therefore, when the temperature of the discharging electrode 110 is increased, the phenomenon, in which foreign substances D in the air accumulate on the discharging electrode 110, thereby lowering the discharge efficiency or generating abnormal noise, may be reduced.

According to the present disclosure, as the discharging electrode 110 is heated by the first voltage provided to the closed circuit including the discharging electrode 110, and the corona discharge occurs in the discharging electrode 110 by the second voltage provided to the open circuit including the counter electrode 120, various effects due to heating of the discharge space may be obtained.

In addition, according to the present disclosure, because a high voltage is not applied to the discharging electrode 110, the plurality of discharging electrodes 110 may be disposed spaced apart in the downstream direction from the charging assembly 100 to the dust collecting assembly 200 between the pair of counter electrodes 120, and thus high charging efficiency may be obtained.

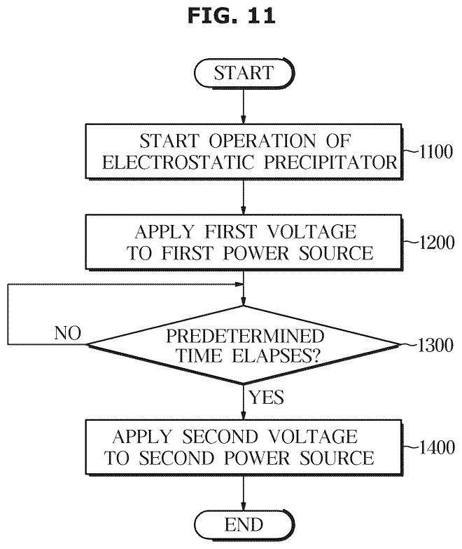

FIG. 11 is a flowchart illustrating an example method of controlling the electrostatic precipitator according to various embodiments.

Referring to FIG. 11, the electrostatic precipitator 1 may initiate an operation based on receiving a user input from the user interface device 10 to initiate the operation of the electrostatic precipitator 1 (1100).

For example, the controller 13 may execute the dust collection operation of the electrostatic precipitator 1 based on receiving an operation start command from the user interface device 10.

The controller 13 may control the first power source 115 to apply the first voltage to both ends of the discharging electrode 110 based on the start of the operation of the electrostatic precipitator 1 (1200).

For example, the first power source 115 may apply the first voltage to both ends of the discharging electrode 110 based on the start of the operation of the electrostatic precipitator 1.

Based on a lapse of the predetermined time after the operation of the electrostatic precipitator 1 starts (yes in 1300), the controller 13 may control the second power source 125 to apply the second voltage to the counter electrode 120 (1400).

For example, the second power source 125 may apply the second voltage to each of the plurality of counter electrodes 120 based on the lapse of the predetermined time after the start of the operation of the electrostatic precipitator 1.

The second power source 125 may apply the second voltage to each of the plurality of counter electrodes 120 in response to the lapse of the predetermined time after the first voltage is applied to both ends of the discharging electrode 110.

The predetermined time may be set as a period of time for the discharging electrode 110 to be heated to the predetermined temperature. For example, the predetermined time may be about 5 seconds.

According to the present disclosure, by applying a high voltage to the counter electrode 120 and heating the discharging electrode 110 to a predetermined temperature before a corona discharge occurs at the discharging electrode 110, the effect of heating the discharge area described above may be obtained.

In addition, according to the present disclosure, foreign substances attached to the discharging electrode 110 may be removed in advance by heating the discharging electrode 110 before applying a high voltage to the counter electrode 120.

According to various embodiments, the controller 13 may control the first power source 115 to allow the current value detected by the current sensor 116 to be maintained at a predetermined value.

For example, the first power source 115 may adjust the first voltage to allow the current value detected by the current sensor 116 to be maintained at the predetermined value. The predetermined value may be set as a temperature for maintaining the discharging electrode 110 at a predetermined temperature.

According to the present disclosure, the temperature of the discharging electrode 110 may be maintained at an optimal temperature.

According to various embodiments, the electrostatic precipitator 1 may operate in an automatic operation mode, and the controller 13 may initiate the operation of the electrostatic precipitator 1 based on dust information received from the dust sensor 117 satisfying a predetermined condition.

The electrostatic precipitator 1 according to an embodiment may be mounted on an air conditioner 2.

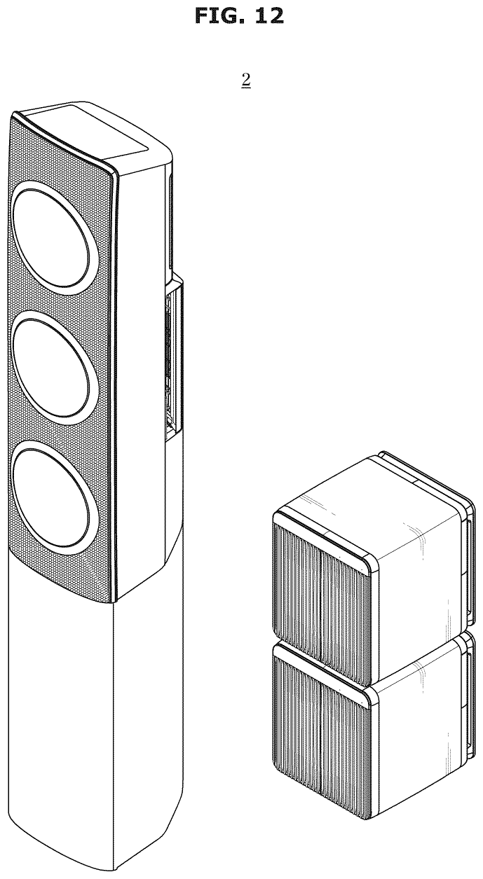

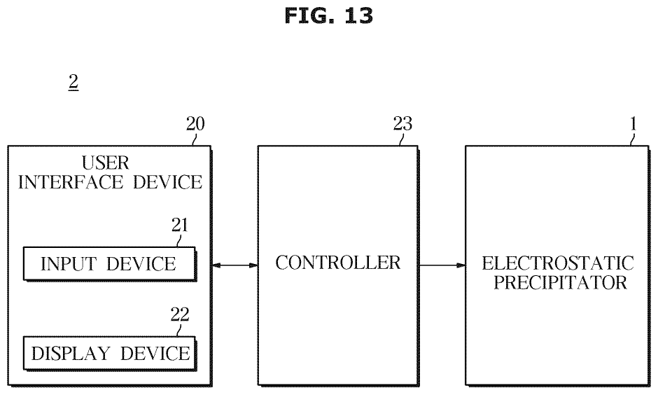

FIG. 12 is a perspective view illustrating an exterior of an example air conditioner according to various embodiments, and FIG. 13 is a block diagram illustrating an example configuration of the air conditioner according to various embodiments.

Referring to FIG. 12, the air conditioner 2 in the present disclosure may include an air purifier and an air conditioner having an air purification function.

The air conditioner 2 according to an embodiment may include the electrostatic precipitator 1.

The electrostatic precipitator 1 generates a corona discharge using high voltage, thereby consuming a lot of power.

Accordingly, the air conditioner 2 according to an embodiment may determine whether to operate the electrostatic precipitator 1 according to a user's intention.

Referring to FIG. 13, the air conditioner 2 according to an embodiment may include a user interface device (e.g., including interface circuitry) 20, a controller (e.g., including circuitry) 23, and the electrostatic precipitator 1.

The user interface device 20 may include an input device 21 including various circuitry provided to receive a user input for controlling an operation of the air conditioner 2, and a display device 22 provided to display setting and/or operation information in response to the user input.

The user interface device 20 may provide a user interface for interaction between a user and the air conditioner 2.

The air conditioner 2 may start an air conditioning operation based on receiving an air conditioning command through the user interface device 20. The air conditioning operation and the dust collection operation may be different from each other.

For example, the air conditioning operation is an operation to control a temperature of air around the air conditioner 2, and the dust collection operation is an operation to remove foreign substances in the air around the air conditioner 2.

A description of the input device 21 and the display device 22 of the air conditioner 2 is the same as or similar to that of the input device 11 and the display device 12 of the electrostatic precipitator 1, and a redundant description thereof may not be repeated here.

The user interface device 20 may receive an input for executing the operation of the electrostatic precipitator 1.

For example, the user interface device 10 may provide an interface for operating the air conditioner 2 in a cleaning mode, and a user can operate the air conditioner 2 in the cleaning mode through the interface.

“Cleaning mode” may refer, for example, to a mode in which the electrostatic precipitator 1 included in the air conditioner 2 operates, and there are no limits in a name thereof.

The controller 23 may include a processor configured to generate a control signal regarding the operation of the air conditioner 2, and a memory provided to store a program, an application, an instruction, and/or data for the operation of the electrostatic precipitator 1. The processor and the memory may be implemented as separate semiconductor devices, or may be implemented as a single semiconductor device. In addition, the controller 23 may include a plurality of processors or a plurality of memories. The controller 23 may be provided at various locations inside the air conditioner 2. The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The controller 23 may control the operation of the air conditioner 2 based on a command received from the user interface device 10.

For example, the controller 23 may control a heat pump (not shown) based on receiving a user input to execute an air conditioning mode.

As another example, the controller 23 may control the electrostatic precipitator 1 based on receiving a user input to execute the cleaning mode.

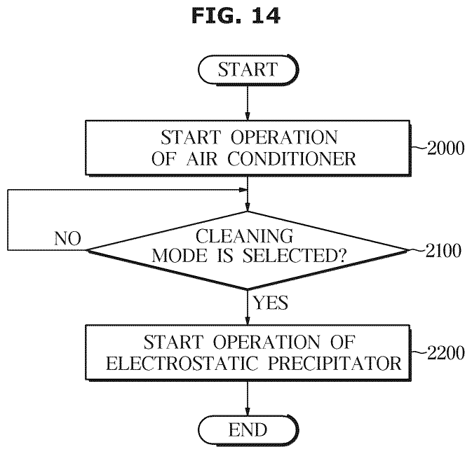

FIG. 14 is a flowchart illustrating an example method of controlling the air conditioner according to various embodiments.

Referring to FIG. 14, the air conditioner 2 may initiate an operation of the air conditioner 2 based on receiving a user input for executing the air conditioning mode (2000).

The start of the operation of the air conditioner 2 may refer, for example, to starting the operation to control the temperature of air around the air conditioner 2.

While the air conditioner 2 operates, the user interface device 20 may receive a user input for selecting the cleaning mode.

The controller 23 may initiate an operation of the electrostatic precipitator 1 (2200) based on receiving a user input for executing the cleaning mode (yes in 2100).

When the operation of the electrostatic precipitator 1 is initiated, as shown in FIG. 11, the controller 23 may control the electrostatic precipitator 1 to allow the first power source 115 to apply the first voltage and to allow the second power source 125 to apply the second power based on the lapse of the predetermined time.

The controller 23 may stop the operation of the electrostatic precipitator 1 based on receiving a user input to stop the cleaning mode.

According to the present disclosure, it is possible to prevent and/or reduce unintended power consumption by operating the electrostatic precipitator 1 according to the user's selection.

In addition, according to the present disclosure, by first heating the discharging electrode 110 of the electrostatic precipitator 1 and then applying a high voltage to the counter electrode 120, the effect of increasing the temperature of the discharge area may be obtained.

The disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored. For example, there may be a Read Only Memory (ROM), a Random Access Memory (RAM), a magnetic tape, a magnetic disk, a flash memory, and an optical data storage device.

Storage medium readable by a computer, may be provided in the form of a non-transitory storage medium. “Non-transitory storage medium” may refer, for example, to a storage medium including a tangible device and does not contain a signal (e.g., electromagnetic wave), and this term includes a case in which data is semi-permanently stored in a storage medium and a case in which data is temporarily stored in a storage medium. For example, “non-transitory storage medium” may include a buffer in which data is temporarily stored.

The method according to the various disclosed embodiments may be provided by being included in a computer program product. Computer program products may be traded between sellers and buyers as commodities. Computer program products are distributed in the form of a device-readable storage medium (e.g., compact disc read only memory (CD-ROM)), or are distributed directly or online (e.g., downloaded or uploaded) between two user devices (e.g., smartphones) through an application store (e.g., Play Store™). In the case of online distribution, at least a portion of the computer program product (e.g., downloadable app) may be temporarily stored or created temporarily in a device-readable storage medium such as the manufacturer's server, the application store's server, or the relay server's memory.

While the present disclosure has been illustrated and described with reference to various example embodiments, it will be understood by those skilled in the art that various changes in form and detail may be made without departing from the true spirit and full scope of the present disclosure, including the appended claims and their equivalents. It will also be understood that any of the embodiment(s) described herein may be used in conjunction with any other embodiment(s) described herein.

What is claimed is:

1. An electrostatic precipitator comprising:
a charging assembly; and
a dust collecting assembly comprising a sheet configured to collect foreign substances charged in the charging assembly,
wherein the charging assembly comprises:
a plurality of counter electrodes;
at least one discharging electrode arranged between the plurality of counter electrodes;
a first power source configured to apply a first voltage to both ends of the discharging electrode; and
a second power source configured to apply a second voltage to each of the plurality of counter electrodes,
wherein the first power source and the discharging electrode form a closed circuit, and the second power source and the plurality of counter electrodes form an open circuit.

2. The electrostatic precipitator of claim 1, wherein
a magnitude of the second voltage is greater than a magnitude of the first voltage.

3. The electrostatic precipitator of claim 2, wherein
the magnitude of the second voltage is 1000 V or greater and the magnitude of the first voltage is 20 V or less.

4. The electrostatic precipitator of claim 1, wherein
the first power source includes an alternating current (AC) power source or a direct current (DC) power source, and the second power source includes a DC power source.

5. The electrostatic precipitator of claim 1, wherein
the discharging electrode is configured to generate heat by the first voltage, and
the discharging electrode is configured to provide corona discharge by the second voltage.

6. The electrostatic precipitator of claim 1, wherein
the discharging electrode has a specified resistance value, and the magnitude of the first voltage is specified based on the specified resistance value.

7. The electrostatic precipitator of claim 1, wherein
the at least one discharging electrode comprises a plurality of discharging electrodes spaced apart from each other in a downstream direction from the charging assembly to the dust collecting assembly.

8. The electrostatic precipitator of claim 7, wherein
the plurality of discharging electrodes is connected in parallel to the first power source.

9. The electrostatic precipitator of claim 1, wherein
the first power source is configured to apply the first voltage to both ends of the discharging electrode based on a start of operation of the electrostatic precipitator; and
the second power source is configured to apply the second voltage to each of the plurality of counter electrodes based on a lapse of a specified time after the operation of the electrostatic precipitator starts.

10. The electrostatic precipitator of claim 1, further comprising:
a current sensor configured to detect a current flowing in the closed circuit formed by the first power source and the discharging electrode,
wherein the first power source is configured to adjust the first voltage to allow the current value detected by the current sensor to be maintained at a specified value.

11. The electrostatic precipitator of claim 1, wherein
one end of the first power source is connected to the discharging electrode, and an other end of the first power source is connected to ground and the discharging electrode.

12. The electrostatic precipitator of claim 11, wherein
the first power source and the discharging electrode include a grounded common node.

13. The electrostatic precipitator of claim 1, wherein
one end of the second power source is connected to each of the plurality of counter electrodes, and an other end of the second power source is connected to ground.

14. The electrostatic precipitator of claim 13, wherein
the plurality of counter electrodes is ungrounded.

15. The electrostatic precipitator of claim 1, wherein
the discharging electrode includes a wire electrode, and
the counter electrode includes a plate electrode.
